(19) United States
(12) Patent Application Publication
(10) Pub. No.: US 2012/0210835 A1
(43) Pub. Date: Aug. 23, 2012

(54) TRANSFER CAR, AND A METHOD OF MACHINING A PANEL IN A FLAT BED MACHINE

(75) Inventors: Petrus Louis Gerardus Schmeits, Rotterdam (NL); Marcel Johan Dalitso Fleuren, Delft (NL); Jaap Breeuwer, Delft (NL); Jort Nijhuis, Delft (NL); Henri Eskonen, Munchen (DE)

(73) Assignee: COMBIHOUT BEHEER B.V., Rotterdam (NL)

(21) Appl. No.: 13/395,614

(22) PCT Filed: Sep. 14, 2010
(86) PCT No.: PCT/NL2010/050589

§ 371 Date: Apr. 30, 2012

(30) Foreign Application Priority Data
Sep. 14, 2009 (NL) 2003485

(51) Int. Cl. B62B 3/02; B26D 7/00; B62B 3/10

(52) U.S. Cl. 83/13; 280/35

(57) ABSTRACT

A transfer car to carry a panel, the transfer car including a chassis, a holding frame to hold a panel, the holding frame having a translatable frame part, which translatable frame part is translatable in a work position of the holding frame, and a tilting mechanism supporting pivotably the holding frame, wherein the holding frame is pivotable about a pivot axis between an upright transport position and a substantially horizontally work position, and wherein the chassis supports the tilting mechanism.

### FIELD

The present invention relates to a transfer car for carrying a panel, and a method of machining a panel in a flat bed machine using such transfer car.

### SUMMARY

The handling of large panels normally requires two persons. The use of transfer cars to transport one or more panels from a central storage to the flat bed machine is known. The transfer of the panels from the central storage to the transfer car and from the transfer car to the bed of a flat bed machine, for instance a sawing machine usually requires two persons.

German Patent Application Publication No. DE 196 21 012 discloses a transfer car for carrying a panel. The transfer car comprises a chassis having four wheels. The chassis supports a tilting mechanism and a holding frame. The holding frame is pivotable about a horizontal pivot axis of the tilting mechanism between an upright transport position and a substantially horizontally work position.

With the transfer car of DE 196 21 012, a panel may be transported from the central storage to the flat bed machine, and tilted from the transport position to the work position. From this work position the panel can be slid from the transfer car to the bed of the machine for further processing. Sliding the panel from the transfer car on the flat bed machine only requires one person. After the panel is placed on the bed of the machine, the transfer car may be moved back to the central storage for a new panel.

Accordingly, it desirable to provide, for example, a transfer car which may be used to transport panels to flat bed machines, which transfer car facilitates the handling of panels.

In an embodiment, there is provided a transfer car for carrying a panel, comprising
a chassis,
a holding frame for holding a panel, the holding frame comprising a translatable frame part, which translatable frame part is translatable in a direction substantially parallel to a main plane of a panel supported on the holding frame, and
a tilting mechanism supporting pivotably the holding frame, wherein the holding frame is pivotable about a pivot axis between an upright transport position and a substantially horizontally work position, and wherein the chassis supports the tilting mechanism.

The transfer car carrying a panel can be located next to the flat bed machine, and a panel supported by the transfer car can be partially slid on the bed of the machine so that the panel also is partially supported on the transfer car. Subsequently, the panel is positioned at a start position of the panel to be machined in the flat bed machine, and the panel is guided through the machine. Thereby, the translatable frame part may be translated in the direction of movement of the panel so that the panel is guided in this direction by the translatable frame part.

An advantage of the transfer car is that the translatable frame part of the holding frame may be used during machining of the panel to guide the panel on the bed of a flat bed machine. In flat bed machines, it is of importance that the panel remains substantially flat during machining of the panel. Many guiding devices to be mounted in or on the flat bed machine have been proposed to improve the guiding of the panel on the machine bed. With the transfer car described herein the transfer car may be used to guide the panel on the bed of the machine. As the panel is supported on the translatable frame part, there is no substantial friction between the surface of the holding frame and the panel during movement of the panel on the bed of the flat bed machine. This makes the movement of the panel easier and more certain. As a result, there is less chance of, for example, sawing errors.

The translatable frame part of the holding frame is desirably arranged at the top side of the holding frame when arranged in the transport position.

The holding frame may comprise any structure to support a panel, for instance an open construction of elongate frame parts and/or a flat shaped object on which the panel is supported.

The translatable frame part of the holding frame may be mounted on a stationary part of the holding frame by any type of bearing, for instance a sliding bearing, suitable to facilitate the sliding movement of the translatable frame part of the holding frame. The maximum displacement of the translatable frame part is desirably at least half the length of the holding frame in the direction of translation.

A panel may be any plate shaped object, in particular a plate shaped object to be machined on a flat bed machine, such as a flat bed sawing machine. The main plane of the panel is the plane in which the largest dimensions of the panel extend. The panel may be square, rectangular or have any other suitable shape.

An upright position of the panel is a position wherein the panel is mainly supported on one of its sides. In this position the angle between the main plane of the panel and a horizontal plane will normally be in the range of 60 to 90 degrees.

In the work position the holding frame is arranged in a position to support a panel with its main plane in a substantially horizontal plane.

In an embodiment, the translatable frame part is translatable substantially parallel to the pivot axis. By translation of the translatable frame part parallel to the pivot axis, the chassis is less likely to form an obstacle during translation of the translatable frame part. For instance, when the translatable frame part of the holding frame is arranged at the top side of the holding frame when arranged in the transport position, the translatable frame part is located at an edge of the transfer car in the work position. In this position, the translatable holding frame is no longer positioned vertically above the chassis. When in such embodiment the translatable frame part is translatable parallel to the pivot axis, the displacement of the translatable frame part is carried out next to the chassis, and thus a person pushing the translatable frame part is not, or less, hindered by the chassis or another part of the transfer car during translation of the translatable frame part.

In an embodiment, the transfer car comprises a storage compartment to hold one or more panels in an upright position and wherein a panel in the storage compartment may be loaded on the holding frame when the holding frame is in the transport position. In the transfer car of DE 196 21 012, for each panel the transfer car has to be moved between the central storage and the flat bed machine to take a new panel from the storage. When the transfer car is provided with a storage compartment for multiple panels, the transfer car can be loaded with multiple panels before being arranged next to the flat bed machine. When positioned the panels may be subsequently placed on the holding frame, and tilted from the transport position to the work position and machined in the flat bed machine.

It is remarked that such storage compartment to hold one or more panels in an upright position may be applied in a transfer car to carry a panel, the transfer car comprising a chassis, a holding frame to hold a panel, and a tilting mechanism supporting pivotably the holding frame, wherein the holding frame is pivotable about a pivot axis between an upright transport position and a substantially horizontally work position, and wherein the chassis supports the tilting mechanism, i.e. without a translatable frame part in the holding frame.

In an embodiment, the holding frame comprises holding feet arranged at the bottom side of the holding frame in the upright position to support a bottom rim of the panel. These holding feet which may be configured as one or more extensions at the bottom side of the holding frame in the transport position, may support the bottom rim of the panel and facilitate pivoting the panel from the transport position to the work position.

In an embodiment, the transfer car comprises a support arm to support the holding frame in the work position. This support arm may be movably mounted on the chassis between a rest position and a supporting position. The support may be necessary to support the weight of the holding frame and the panel when the holding frame and panel are positioned in the work position.

In a further embodiment, the transfer car comprises a locking device to lock the holding frame in the transport position, the locking device having a locked position, wherein the holding frame is locked in the transport position and an unlocked position wherein the holding frame may be tilted towards the work position.

In an advantageous further embodiment, the locking device can only be positioned in the unlocked position when the support arm is positioned in the support position. In such an embodiment it is avoided that the holding frame is brought to the work position before the support arm is placed in the supporting position.

In an embodiment, the transfer car comprises a lifting mechanism to displace the holding frame in a substantially vertical direction between different height positions. Since not all flat bed machines have the same bed height, it may be advantageous to provide a lifting mechanism with which the height of a panel in the work position may be adjusted to the height of the bed of the flat bed machine. As an alternative, the height of the panel may be adjusted by providing on the ground surface at appropriate locations next to the flat bed machine positioning blocks on which the transfer car may be positioned or positioning holes wherein the transfer car may be placed.

The height of the positioning blocks or depth of the positioning holes is chosen to locate the panel at the appropriate height. Ramps may be provided to roll the wheels on the positioning blocks or in the positioning holes. A further advantage of positioning blocks or positioning holes is that these positioning blocks or positioning holes are suitable for easily positioning the transfer car at a correct position with respect to the flat bed machine.

An embodiment of the invention further provides a method of machining a panel in a flat bed machine, comprising:
providing a transfer car for carrying a panel, the transfer car comprising a chassis, a holding frame to hold a panel, and a tilting mechanism supporting pivotably the holding frame, wherein the holding frame is pivotable about a pivot axis between an upright transport position and a substantially horizontally work position, and wherein the chassis supports the tilting mechanism,
placing a panel on the holding frame while the holding frame is in the transport position,
tilting the holding frame to the work position,
sliding the panel partially on or in the flat bed machine, and
machining the panel, while the panel is partially supported on the transfer car.

A flat bed machine is a machine in which a panel may be machined while the panel is at least partially supported on a bed, i.e. a substantially horizontal surface.

An embodiment of the invention is based on the insight that a transfer car in which a panel may be supported in a horizontal position may be used to guide the panel during machining in a flat bed machine.

In an embodiment, the holding frame comprises a translatable frame part, which translatable frame part is translatable in the work position of the holding frame, and wherein the machining the panel comprises guiding the panel by translation of the translatable frame part of the holding frame. In such embodiment, the transfer car described herein may be used. The translation of the translatable frame part is desirably substantially parallel to the machining direction.

In an embodiment, the transfer car carries multiple panels in a storage compartment of the transfer car, and multiple panel are subsequently loaded from the storage compartment on the holding frame in the transport position, and machined after being tilted to the work position. The use of such a storage compartment decreases the number of required visits to the central storage. This results in more efficient handling of panels.

In an embodiment, the method comprises before tilting the holding frame to the work position, positioning the transfer car on a predetermined location with respect to the flat bed machine. In order to properly use the transfer car in combination with the flat bed machine, correct positioning of the transfer car with respect to the flat bed machine is of importance. One or more positioning items, such as one or more positioning blocks or positioning holes against, on or in which the transfer car may be placed, may be used to facilitate positioning of the transfer car with respect to the flat bed machine.

In an embodiment, the method comprises adjusting the height of the holding frame in work position before the sliding of the panel partially on or in the flat bed machine. Not all flat bed machines have the same height. For proper machining of a panel, it is desirable that the height of holding frame in the work position substantially corresponds with the height of the bed of the flat bed machine. When necessary the height of the holding frame and panel may be adjusted before machining of the panel in the flat bed machine. The height may be adjusted by using a lifting mechanism in the transfer car, or by providing any other suitable means for adjusting the height of the holding frame with respect to the bed of the flat bed machine, such as one or more positioning blocks or holes.

The transfer car described herein may in particular be used in workshops for the transfer of larger panels, such as wooden or MDF panels, which are to be processed on a flat bed machine such as a flat bed sawing machine. These panels are often stored in a central storage in the workshop, where they are positioned in an upright or horizontal position.

### BRIEF DESCRIPTION OF THE DRAWINGS

Further features and advantages will now be described with respect to an embodiment of the invention, while reference is made to the accompanying drawings in which:

FIG. 1 shows a side view of the transfer car of an embodiment of the invention in a transport position;

FIG. 2 shows a side view of the transfer car of an embodiment of the invention in a work position;

FIG. 3 shows a top view of the transfer car of an embodiment of the invention in a work position; and

FIG. 4 shows a perspective view of the use of the transfer car of an embodiment of the invention in combination with a flat bed sawing machine.

### DETAILED DESCRIPTION

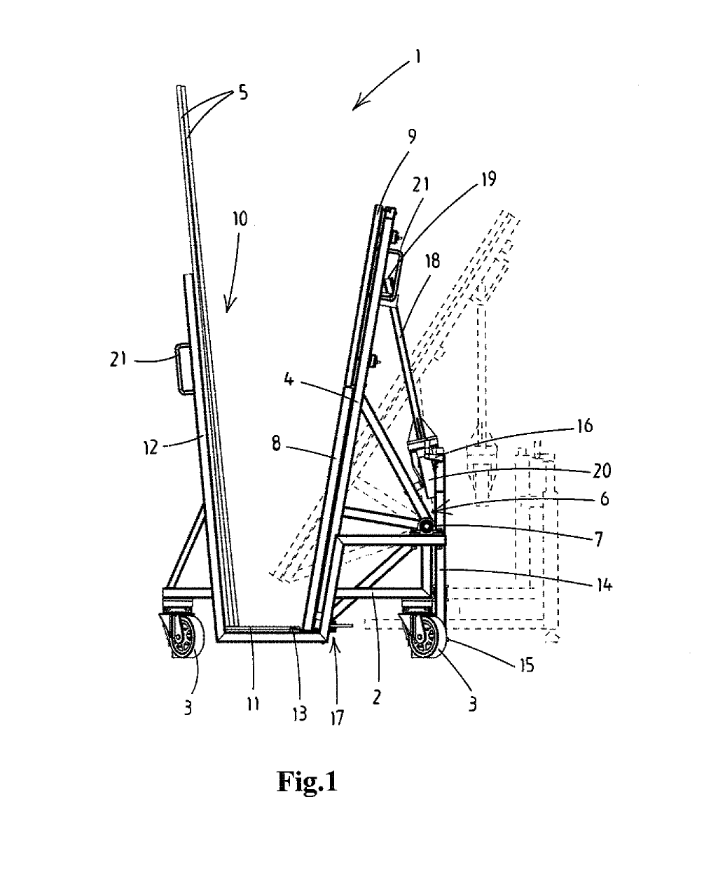

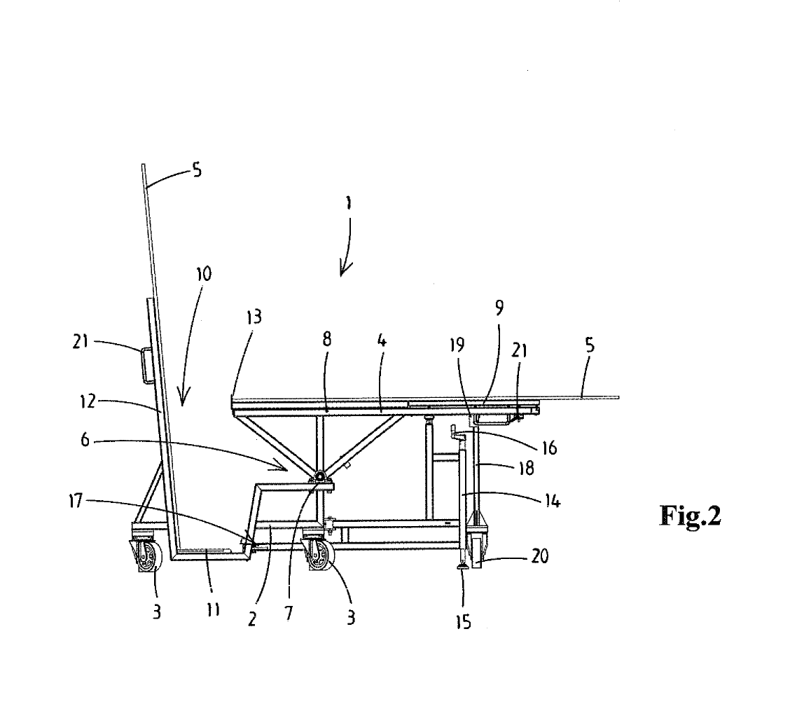

FIGS. 1 and 2 show side views of a transfer car according to an embodiment of the invention and generally indicated with the reference numeral 1.

The transfer car 1 comprises a chassis 2 having two swivel and two fixed wheels 3 to movably support the transfer car on a ground surface, a holding frame 4 to support a panel 5, and a tilting mechanism 6 supporting pivotably the holding frame 4. The transfer car is in particular suitable for supporting larger panels having dimensions of more than 1.5 meters, for instance 2×2 meters.

The holding frame 4 is pivotable about a pivot axis 7 between an upright transport position (FIG. 1) and a substantially horizontally work position (FIG. 2). In FIG. 1, an intermediate position of the holding frame 4 between the transport position and the work position is shown in dashed lines.

The holding frame 4 comprises a stationary part 8 and a translatable frame part 9 which is translatable with respect to the stationary frame part 8 in the plane of the holding frame 4.

The transfer car 1 comprises a storage compartment 10 to hold one or more panels 5 in an upright position. An advantage of such a storage compartment 10 is that multiple panels 5 may be arranged on the transfer car before the transfer car is transferred to the location of use, for instance a flat bed machine. Between machining of different plates the transfer car 1 does not have to be moved between the central storage of panels and the flat bed machine.

The storage compartment 10 comprises a bottom wall 11 and a side wall 12. The side wall is arranged at the side of the transfer car opposite the holding frame 4.

The holding frame 4 comprises a number of feet 13, each arranged at a bottom side of the holding frame 4 in transport position. These feet 13 are provided to support the bottom rim of the panel 5 in particular during the beginning of the tilting movement of the holding frame 4 from the transport position to the work position.

In transport position the feet 13 are mainly located under the bottom wall 11 of the storage compartment 10 to make the positioning of a panel 5 on the holding frame 4 easier so that one person may move a panel from the storage compartment 10 to the holding frame 4. As soon as the tilting movement of the holding frame 4 is started the feet 13 rise above the bottom wall 11, and support the bottom rim of the panel 5.

A support arm 14 is arranged to support the holding frame 4 in the work position. This support arm 14 is provided so that bending of the holding frame, or falling over of the transfer car is avoided.

The support arm 14 is pivotable about a vertical axis between a rest position (FIG. 1 solid lines) and a supporting position (FIG. 1 dashed lines; FIG. 2 solid lines). The support arm 14 comprises an extendible foot 15 to be extended in the supporting position on the ground surface to find support, and drawn up to make a movement between the rest position and supporting position possible. The extendible foot 15 can be extended and drawn up by rotation of the rotation handle 16 at the top side of the support arm 14.

The transfer car 1 comprises a locking device 17 to lock the holding frame 4 in the transport position. The locking device 17 has a locked position, wherein the holding frame 4 is locked in the transport position and an unlocked position wherein the holding frame 4 may be tilted towards the work position. In an embodiment, the locking device 17 can only be brought into the unlocked position when the support arm 14 is positioned in the supporting position. In such an embodiment with such a locking device it is not possible that the holding frame 4 is brought in the work position before the support arm 14 is positioned in the supporting position to support the holding frame 4. This avoids undesired bending of the holding frame 4 and panel 5 and/or falling over of the transfer car 1.

Further, the transfer car 1 comprises a movable support 18 to support the translatable frame part 9 during translation. The movable support 18 is pivotably attached to the translatable frame part 9 at pivot axis 19. The pivot axis 19 has been arranged at the front end of the translatable frame part 9 in the outward translation direction. The movable support 18 comprises a support wheel 20 which contacts the ground surface, when the holding frame is in the work position to support the translatable frame part 9.

Handles 21 are provided to facilitate the handling of the transfer car 1 during riding and tilting of the holding frame 4.

In FIG. 1, two panels are placed in the storage compartment 10. In FIG. 2 one of these panels 5 is placed on the holding frame 4 and the holding frame is positioned in the work position, therewith positioning the panel 5 in a substantial horizontal position.

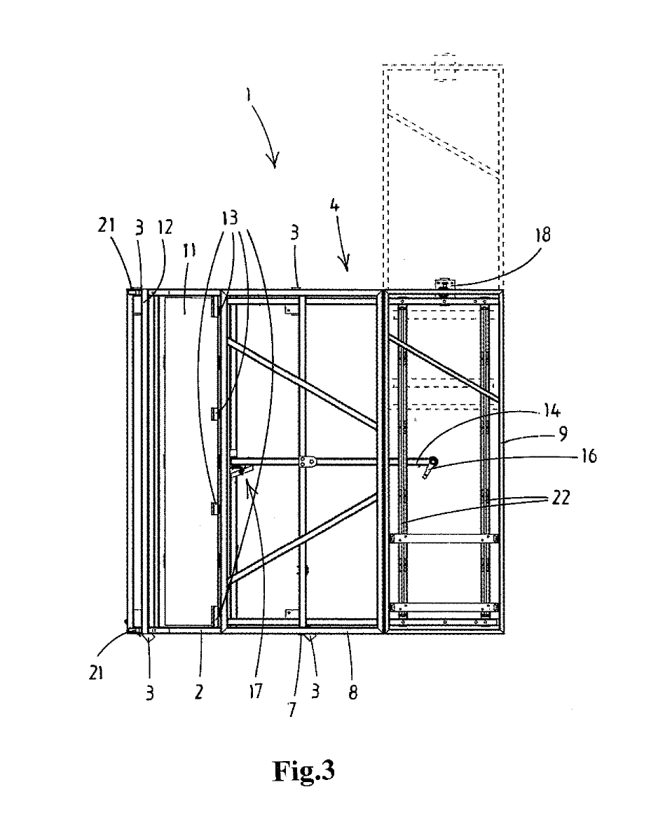

FIG. 3 shows a top view of the transfer car 1. In FIG. 3, the translatable frame part 9 is shown in solid lines in the position just after being tilted from the transport position to the work position. In dashed lines the position is shown when the translatable frame part is fully translated in the translation direction. Bearing 22 is provided between the stationary part 8 and the translatable frame part 9 to facilitate the translation of the translatable frame part 9. The bearing 22 may be any suitable means to improve the sliding movement between the stationary frame part 8 and the translatable frame part 9.

It can be seen that the translation is parallel to the pivot axis 7 of the holding frame 4. Furthermore, in an embodiment, the translatable frame part 9 is translatable over at least half the length of the holding frame 4, approximately two thirds of the length of the holding frame 4 in the direction of translation.

Since the translatable frame part 9 is arranged at the top side of the holding frame when arranged in the transport position, the translatable frame part 9 is located at the edge of the transfer car 1 in the work position. In this position, the translatable frame part 9 is no longer positioned vertically above the chassis 2. As the translation is parallel to the pivot axis 7, the displacement of the translatable frame part 9 is carried out next to the chassis 2, and a person pushing the translatable frame part 9, directly or indirectly, is not, or less, hindered by the chassis 2 or another part of the transfer car 1 during translation of the translatable frame part 9.

The transfer car 1 is, for example, in particular suitable to be used in conjunction with a flat bed machine.

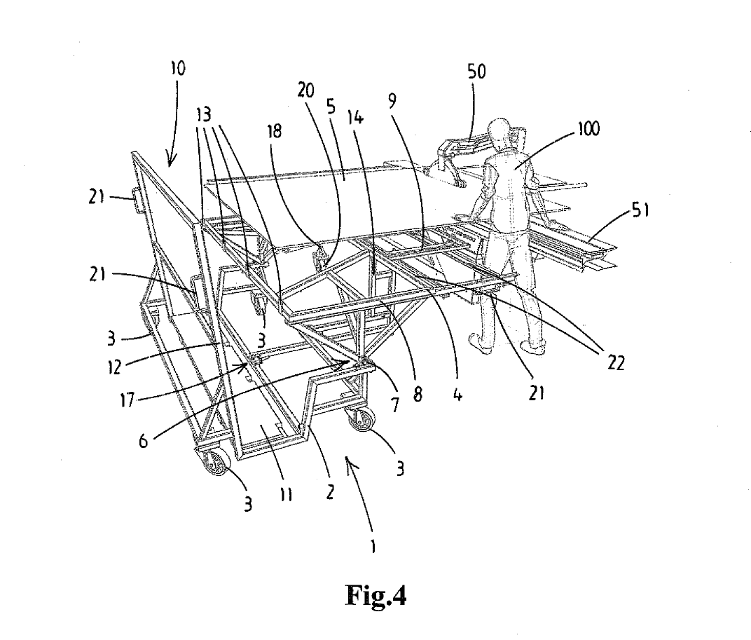

FIG. 4 shows a transfer car 1 arranged next to a flat bed sawing machine 50. A panel 5 is being machined in the sawing machine 50, while the panel is partially supported on the bed 51 of the flat bed machine and partially on the holding frame 4. The person 100 sawing the panel pushes the panel, and as a consequence, the translatable frame part 9 is translated in the translation direction to guide the panel while being machined in the sawing machine 50.

The transfer car 1 may be used as follows.

In a central storage one or more panels are placed in the storage compartment 10 of the transfer car. This may require two persons, but the rest of the steps may be carried out by only one person.

The transfer car is transferred to a flat bed machine on which the one or more panels are to be machined. The transfer car 1 is positioned in an appropriate position with respect to the sawing machine 50. This position may be indicated on the ground surface, and one or more positioning items may be provided to facilitate the positioning of the transfer car 1.

When required the height of the holding frame in the work position may be adjusted to match with the height of the bed 51 of the sawing machine 50. This height adjustment may be carried out by a height adjustment device arranged on the transfer car 1, or by any other suitable means or device to locate the panel on an appropriate height with respect to the bed 51.

After positioning of the transfer car, the support arm 14 may be arranged in the supporting position and a first panel 5 may be placed on the holding frame in transport position, by sliding or tilting the panel 5 over the bottom wall 11 until the bottom rim of the panel 5 is located on or above the feet 13.

By placing the support arm 14 in the supporting position, the locking device 17 is arranged in the unlocked position so that the holding frame 4 holding the panel 5 may be tilted to the work position.

After tilting the holding frame 4 to the work position, the panel 5 is usually only supported by the holding frame 4; the panel 5 is not likely to be supported on the flat bed machine 51 in the correct position for machining. Thus, before machining of the panel the panel 5 is slid on the bed 51 in the correct start position for machining, whereby the panel 5 partially rests on the bed 51 and partially on the holding frame 4 of the transfer car 1.

Then the panel 5 is machined in the sawing machine 50 by moving the panel in a machining direction, in this case parallel to the main plane of the sawing blade, as shown in FIG. 4. During this movement the panel is guided by the translatable frame part 9 which is translated together with the panel 5 in the translation direction which is parallel to the machining direction.

After machining of the panel 5 has been finished, the holding frame 4 may be positioned in the transport position for loading of a new panel 5 to be machined on the sawing machine 50.

1. A transfer car to carry for carrying a panel, the transfer car comprising:
a chassis;
a holding frame to hold a panel, the holding frame comprising a translatable frame part, which translatable frame part is translatable in a direction substantially parallel to a main plane of the panel supported on the holding frame; and
a tilting mechanism supporting pivotably the holding frame, wherein the holding frame is pivotable about a pivot axis between an upright transport position and a substantially horizontally work position, and wherein the chassis supports the tilting mechanism.

2. The transfer car of claim 1, wherein the translatable frame part is translatable substantially parallel to the pivot axis.

3. The transfer car of claim 1, wherein the translatable frame part is translatable over at least half the length of the holding frame in a direction of translation.

4. The transfer car of claim 1, wherein the transfer car comprises a storage compartment to hold a panel in an upright position and wherein a panel in the storage compartment may be loaded on the holding frame when the holding frame is in the transport position.

5. The transfer car of claim 1, wherein the holding frame comprises holding feet arranged at the bottom side of the holding frame in the upright position to support a bottom rim of the panel.

6. The transfer car of claim 1, wherein the transfer car comprises a support arm to support the holding frame in the work position.

7. The transfer car of claim 6, wherein the support arm is movably mounted on the chassis between a rest position and a supporting position.

8. The transfer car of claim 7, wherein the transfer car comprises a locking device to lock the holding frame in the transport position, the locking device having a locked position wherein the holding frame is locked in the transport position, and an unlocked position wherein the holding frame may be tilted towards the work position, wherein the locking device can only be positioned in the unlocked position when the support arm is positioned in the supporting position.

9. The transfer car of claim 1, wherein the transfer car comprises a lifting mechanism to displace the holding frame in a substantially vertical direction between different height positions.

10. The transfer car of claim 1, wherein the translatable frame part comprises a movable support to support the translatable frame part during translation.

11. A transfer car to carry a panel, the transfer car comprising:
a chassis;
a holding frame to hold a panel;
a tilting mechanism supporting pivotably the holding frame, wherein the holding frame is pivotable about a pivot axis between an upright transport position and a substantially horizontally work position, and wherein the chassis supports the tilting mechanism; and,
a storage compartment to hold a panel in an upright position, wherein a panel in the storage compartment may be loaded on the holding frame when the holding frame is in the transport position.

12. The transfer car of claim 11, wherein the holding frame comprises holding feet arranged at the bottom side of the holding frame in the upright position, wherein the storage compartment comprises a bottom wall, and wherein in the upright position of the holding frame, the holding feet are at least partially arranged below a top surface of said bottom wall.

13. The transfer car of claim 11, wherein the storage compartment comprises a side wall opposite the holding frame to provide support to the panel in the storage compartment.

14. (canceled)

15. A method of machining a panel in a flat bed machine, the method comprising:
providing a transfer car to carry a panel, the transfer car comprising a chassis, a holding frame to hold a panel, and a tilting mechanism supporting pivotably the holding frame, wherein the holding frame is pivotable about a pivot axis between an upright transport position and a substantially horizontally work position, and wherein the chassis supports the tilting mechanism,
placing a panel on the holding frame while the holding frame is in the transport position,
tilting the holding frame to the work position,
sliding the panel partially on or in the flat bed machine, and
machining the panel, while the panel is partially supported on the transfer car.

16. The method of claim 15, wherein the holding frame comprises a translatable frame part, which translatable frame part is translatable in the work position of the holding frame, and wherein the machining the panel comprises guiding the panel by translation of the translatable frame part of the holding frame.

17. The method of claim 15, wherein the transfer car carries multiple panels in a storage compartment of the transfer car, and wherein multiple panels are subsequently loaded from the storage compartment on the holding frame in the transport position, and machined after being tilted to the work position.

18. The method of claim 15, comprising, before tilting the holding frame to the work position, positioning the transfer car on a predetermined location with respect to the flat bed machine.

19. The method of claim 15, comprising adjusting the height of the holding frame in the work position before the sliding the panel partially on or in the flat bed machine.

20. The transfer car of claim 11, wherein the transfer car comprises a support arm to support the holding frame in the work position.

21. The transfer car of claim 20, wherein the transfer car comprises a locking device to lock the holding frame in the transport position, the locking device having a locked position wherein the holding frame is locked in the transport position and an unlocked position wherein the holding frame may be tilted towards the work position, wherein the locking device can only be positioned in the unlocked position when the support arm is positioned in a supporting position.
